(19) United States
(12) Patent Application Publication
(10) Pub. No.: US 2008/0277039 A1
(43) Pub. Date: Nov. 13, 2008

(54) Run Flat Tire

(75) Inventors: Masanori Iwase, Osaka (JP); Masahiro Segawa, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/104,557

(22) Filed: Apr. 17, 2008

(30) Foreign Application Priority Data
May 7, 2007 (JP) 2007-122592

(51) Int. Cl. B60C 5/00

(52) U.S. Cl. 152/516

(57) ABSTRACT

A double bead type run flat tire includes a pair of bead sections having annular beads, sidewall sections extending outwardly from the bead sections in a diametrical direction of the tire, reinforcing rubber layers disposed in the sidewall sections, and annular protrusion sections protruding outwardly from at least one bead section in the width direction of the tire including an annular bead. The second moment Iw of area in the width direction and the second moment Iz of area in the diametrical direction in a section of the bead along the tire meridian satisfies the relationship: 49 mm⁴≦Iw≦524 mm⁴, 7 mm⁴≦Iz≦29 mm⁴, and 3.9≦Iw/Iz≦18.2. A protruding portion is formed at the inner side of the bead protruding by more than 0.5 mm from the inner peripheral side face in the annular protrusion section in the diametrical direction of the tire.

### BACKGROUND OF THE INVENTION

1. Field of the Invention

The present invention relates to a double bead type run flat tire provided with a reinforcing rubber layer in a sidewall section, and a bead arranged in an annular protrusion section.

2. Description of the Related Art

In the run flat tire arranged with a reinforcing rubber layer in the sidewall section thereof, even when air pressure within the tire is lowered due to a puncture or the like, the reinforcing rubber layer supports the tire and prevents the tire from becoming completely flat, thereby enabling run flat traveling. However, in a state that the air pressure within the tire is lowered (run flat state), the pressure of the bead section against a rim flange is reduced and the engagement force thereof is lowered. As a result, there arises a problem that the bead section is likely to unseat from a bead seat inwardly resulting in a disengagement of the tire from a rim.

To solve the problem, there has been proposed a so-called double bead type run flat tire in which an annular protrusion section is formed in a bead section at the outside thereof in a width direction of the tire, and an annular bead is disposed in the annular protrusion section (refer to Japanese Unexamined Patent Publication No. 52-121204). As the bead disposed in the annular protrusion section, there are known such beads having a generally square or round shape in cross-section. In the run flat tire of this type, the annular protrusion section including the bead can abut on the rim flange. Therefore, the bead section is restricted from displacing inwardly and prevented from unseating during run flat traveling.

However, as a result of intensive study, the inventors have found that conventional double bead type run flat tires have points to be improved in an aspect of bead unseating resistance. That is, in the state of run flat traveling under a load of a lateral force equivalent to the load while a vehicle is turning, the bead in the annular protrusion section largely displaces outwardly in the width direction of the tire at the rear side of the contact point (refer to Comparative Example 1 in FIG. 4). As a result, the bead compression pressure onto the rim is lowered (refer to Comparative Example 1 in FIG. 5), causing the bead unseating resistance to be deteriorated. Detailed descriptions about the graphs in FIGS. 4 and 5 will be given later along with the embodiments of the invention.

Further, the conventional double bead type run flat tires have a problem in a point of feasibility of tire and rim assembly work. That is, when a tire is assembled with a rim, it is necessary that its bead section is positioned in a rim drop once, and then the tire is filled with air therein causing the bead section to be pressed upwardly by an internal pressure so as to climb over a hump. In the double bead type run flat tire, since the annular protrusion section has also to be pressed up to climb over a rim flange, the above-mentioned internal pressure (pressure for climbing over the hump) has to be raised to an extremely high level. Therefore, the tire and rim assembly work was very difficult and complicated.

The present invention has been proposed in view of the above circumstances. An object of the invention is to provide a double bead type run flat tire that achieves both the bead unseating resistance and the feasibility of tire and rim assembly work at a high level.

### SUMMARY OF THE INVENTION

The object can be achieved by the following present invention. The present invention provides a run flat tire, comprising:

a pair of bead sections each including an annular first bead;

sidewall sections each extending outwardly from each of the bead sections in a diametrical direction of the tire;

reinforcing rubber layers each disposed in each of the sidewall sections; and

an annular protrusion section protruding outwardly from at least one of the bead sections in a width direction of the tire and including an annular second bead,

wherein, when the second moment of area in the width direction is defined as Iw, and the second moment of area in the diametrical direction as Iz in a cross section along the tire meridian, the relationship: 49 mm⁴≦Iw≦524 mm⁴, 7 mm⁴≦Iz≦29 mm⁴, and 3.9≦Iw/Iz≦18.2 is satisfied,

a protruding portion protruding by more than 0.5 mm from an inner peripheral face of the annular protrusion section is formed at the inner side of the second bead in the diametrical direction of the tire.

Here, the second moment Iw of area in the width direction represents the deflection of the second bead in the width direction of the tire. The second moment Iw is calculated as the second moment of area with respect to a neutral axis extending in the diametrical direction of the tire. On the other hand, the second moment Iz of area in the diametrical direction is calculated as the second moment of area with respect to a neutral axis extending in the width direction of the tire.

In the run flat tire according to the invention, the second bead disposed in the annular protrusion section has a configuration that satisfies the above-described relationship of the second moment of area. Therefore, the deflection of the second bead in the width direction of the tire can be suppressed, and flexural rigidity of the second bead in the diametrical direction can be reduced. Accordingly, in a turning state of a vehicle while run flat traveling, the lateral displacement of the second bead can be suppressed; and thus, the bead compression pressure onto the rim can be ensured all over the periphery. In addition to the effect of the protruding portion formed at the inner side of the second bead in the diametrical direction of the tire, which engages with the rim flange, the bead unseating resistance can be effectively increased. Further, assembling with the rim, the annular protrusion section can be raised up to climb over the rim flange without raising the pressure, which is required for climbing over the hump, too high. As a result, the tire according to the invention, while being a run flat tire of double bead type, achieves both the bead unseating resistance and the feasibility of tire and rim assembly work at a high level.

### BRIEF DESCRIPTION OF THE DRAWINGS

FIG. 1 shows a half sectional view of an embodiment of a run flat tire according to the invention;

FIG. 2 shows a sectional view of an essential portion depicting the vicinity of a bead section of the run flat tire;

FIG. 3 shows pattern diagrams of cross sections of second bead of respective test tires;

FIG. 4 shows a graph demonstrating amount of lateral displacement of the second bead with respect to a peripheral position; and

FIG. 5 shows a graph demonstrating bead compression pressure with respect to the peripheral position.

### DETAILED DESCRIPTION OF THE PREFERRED EMBODIMENTS

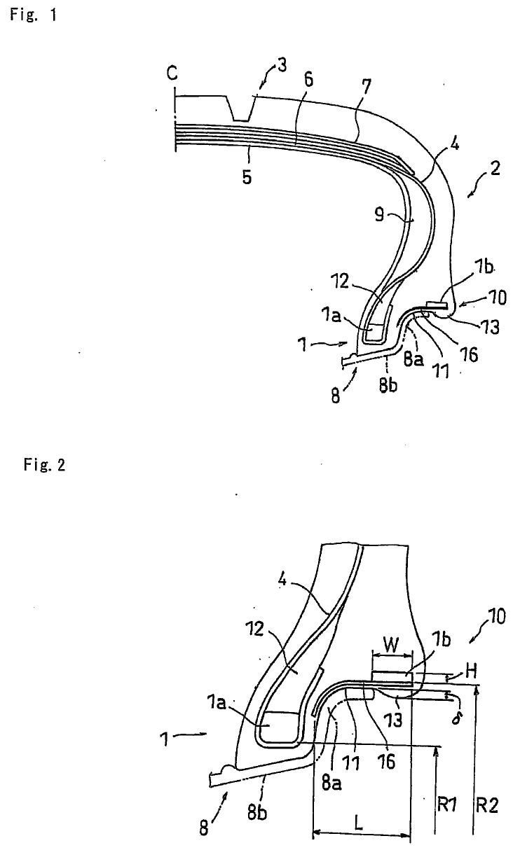

An embodiment of the present invention will be explained with reference to the drawings. FIG. 1 shows a half sectional view of an embodiment of a run flat tire according to the invention. FIG. 2 shows a sectional view of an essential portion depicting the vicinity of a bead section of the run flat tire.

As shown in FIG. 1, the pneumatic tire of the present invention includes a pair of annular bead portions 1, sidewall portions 2 extending from respective bead portions 1 radially outward of the tire, and tread portions 3 connected to the respective sidewall portions 2 radially outward of the tire. The bead section 1 includes a bead la (first bead) consisting of a bundle of bead wires formed in an annular shape in a peripheral direction of the tire, and a bead filler 12 made of hard rubber disposed therein. When the air pressure within the tire is proper, the bead section 1 mounted on a bead seat 8b is pressed onto a rim flange 8a, and thus the tire is engaged with a rim 8.

A carcass layer 4 consists of a ply of cords disposed at an angle of substantially 90° with respect to the tire equator C. The carcass layer 4 is disposed between a pair of bead sections 1. The end portion of the carcass layer 4 is wound up so as to sandwich the bead 1a and the bead filler 12. An inner liner layer 5 is disposed on the carcass ply 4 on an inner peripheral side for keeping air pressure. A belt layer 6 and a belt reinforcing layer 7 are disposed on the carcass ply 4 on an outer peripheral side of the tire. The belt layer 6 reinforces the tire by means of hoop effect.

A reinforcing rubber layer 9 having a crescent shape in cross-section is disposed at the inner side of the carcass layer 4 in the sidewall section 2. When the air pressure within the tire is low, the reinforcing rubber layer 9 supports the tire to reduce the amount of the deflection deformation, and thereby enables the run flat traveling. The reinforcing rubber layer 9 is composed of a rubber layer, rubber harness of which is, for example, 65 to 90° (rubber harness measured in conformity to JIS K6253 Type-A durometer hardness test; hereinafter the same). Any reinforcing rubber layer used in conventional run flat tire may be applied to the reinforcing rubber layer 9 without particular limitation. The reinforcing rubber layer 9 may consist of a plurality of rubber layers having different physicality.

An annular protrusion section 10 is formed at the outer side of the bead section 1 in the width direction of the tire. The annular protrusion section 10 includes an inner peripheral side face 11 that protrudes outwardly from the rim flange 8a in the width direction of the tire facing to the rim flange 8a along a curved outer periphery face thereof. The annular protrusion section 10 is preferably formed at both sides of the bead sections 1. However, the annular protrusion section 10 may be formed on at least one of the bead sections 1. For example, the annular protrusion section 10 may be formed only on the outer side of tires when mounted onto vehicles, on which bead unseating frequently occurs.

According to the embodiment of the invention, a steel chafer 16 is disposed along the inner peripheral side face 11 of the annular protrusion section 10 as a reinforcement material. This arrangement reduces the wear of the inner peripheral side face 11 due to contact with the rim flange 8a and contributes, as well, to increase bead unseating resistance. In place of steel chafer 16, a chafer composed of an organic fiber of rayon, nylon, polyester, aramid or the like may be employed.

The annular protrusion section 10 includes a bead 1b (second bead) composed of a bead wire, which has an annular shape and is disposed therein in the peripheral direction of the tire. The bead 1b according to the embodiment is disposed so that the center thereof is located at the outer side than the outermost side of the rim flange 8a in the diametrical direction of the tire as well as at the outer side in the width direction of the outer. Same as the bead 1a, the bead 1b is not limited to a bundle of steel bead wires or the like. For example, a bundle of organic fibers of aramid or the like, a solid body of rubber bead of a fiber-reinforced rubber or the like, or hollow material may be employed.

The bead 1b has a flat shape in cross section along a tire meridian, which is longer in the width direction of the tire. Defining the second moment of area in the width direction as Iw; and the second moment of area in the diametrical direction as Iz in a cross section along the tire meridian, the bead 1b fulfills the following relationship; i.e., 49 mm⁴≦Iw≦524 mm⁴, 7 mm⁴≦Iz≦29 mm⁴, and 3.9≦Iw/Iz≦18.2. This arrangement suppresses the deflection of the bead 1b in the width direction of the tire; and thus, the lateral displacement is reduced and the flexural rigidity in the diametrical direction is reduced. As a result, the double bead type run flat tire according to the embodiment achieves both of bead unseating resistance and feasibility of tire and rim assembly work at a high level.

The bead 1b according to the embodiment, which has a rectangular shape in cross section, is exemplified by the following bead; i.e., 4 to 13 mm in width dimension W and 50% or less of aspect ratio (height dimension H/width dimension W×100). The second moment Iw of area in the width direction is calculated based on a formula Iw=W³H/12; and the second moment Iz of area in the diametrical direction is calculated based on a formula Iz=WH³/12.

The bead 1b having the above-described configuration is manufactured in the following manner. That is, one bead wire is continuously wound spirally into multiple layers; or a plurality of bead wires are laid up being disposed parallel to each other while controlling the number of rows and number of layers. For example, bead wires disposed in six rows in the width direction of the tire are laid in two layers.

A protruding portion 13 is formed continuously from the inner peripheral side face 11 of the annular protrusion section 10 to the outer side in the width direction of the tire. In order to restrict the bead section 1 from displacing inwardly, the protruding portion 13 has an inside diameter smaller than the outer diameter of the rim flange 8a so as to be engaged with the rim flange 8a. The protruding amount δ of the protruding portion 13 from the inner peripheral side face 11 is set so as to exceed 0.5 mm; preferably set to 0.7 to 1.7 mm. The protruding amount δ is measured using a cut sample at a cross section along the tire meridian. The protruding portion 13 is preferably formed continuously in an annular shape in the identical cross sectional configuration along the peripheral direction of the tire.

Inside diameter R1 of the bead la and inside diameter R2 of the bead 1b are set so that difference in radius (R2−R1)/2 there between is, for example, 15 to 19 mm. Also, distance L in the axial direction of the tire from outer wall surface of the bead section 1 to the outer side face of the bead 1b is set to, for example, 13 to 21.5 mm. The dimensions of the above respective portions are measured using a cut sample at a cross section along the tire meridian.

### EXAMPLES

An example tire which concretely shows the structure and effect of the present invention will be explained.

### [Tire Mass]

Mass of the respective test tires is calculated and evaluated using a comparative Example 1 defined as index 100.

### [Bead Unseating Resistance]

A test tire was mounted onto a rim (rim size: 18×8-JJ) located at the left front of an actual vehicle. With the test tire in a run flat state with air pressure 0 kPa, the vehicle ran from a straight course into a circular course of 20 m radius to perform J-turn clockwise. The test was conducted from a running speed of 25 km/h and the speed was increased until bead unseating occurs; and running speed at the occurrence of the bead unseating was measured. Evaluation was made with respect to the comparative Example 1 defined as index 100. The larger value represents the larger running speed at the occurrence of the bead unseating, and it means superiority in the bead unseating resistance.

### [Feasibility of Tire and Rim Assembly Work]

When the test tire was mounted onto the rim (rim size: 18×8-JJ), air pressure was measured as hump climb-over pressure at a point when both side bead sections climbed over the hump and the tire was mounted onto to the bead seat. Evaluation was made with respect to the comparative Example 1 defined as index 100. The smaller value represents the smaller hump climb-over pressure, and it means the superiority in feasibility of tire and rim assembly work.

### [Ride Comfort Evaluation]

The test tire was mounted onto a rim (rim size: 18×8-JJ), and air pressure was set to 230 kPa. The rim was fixed and vertical load 5,800 N was applied thereto, and deflection amount was measured. Vertical rigidity was calculated by dividing the vertical load by the amount of vertical deflection. Evaluation was made with respect to the comparative Example 1 defined as index 100. The smaller value represents the smaller vertical rigidity, and it means the superiority in ride comfort.

### Comparative Examples 1 to 5 and Examples 1 to 7

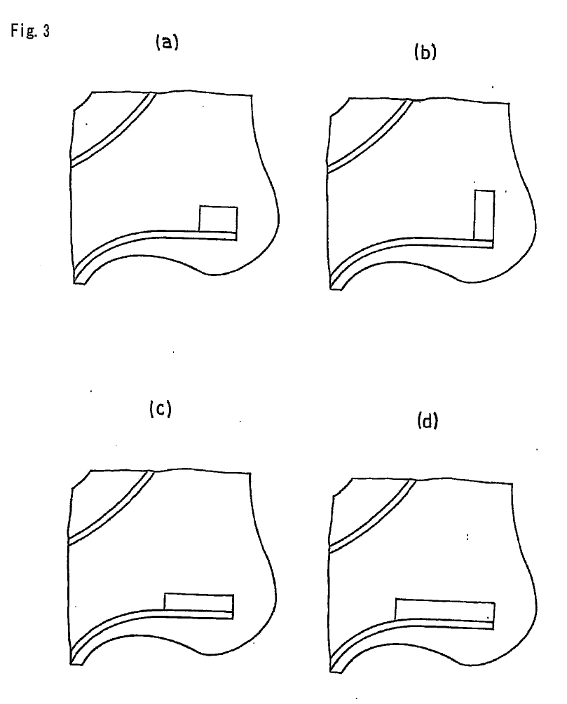

Test tires for Comparative Examples 1 to 5 and Examples 1 to 7 were prepared using run flat tires (tire size: 245/40ZR18), each of which had the structure shown in FIGS. 1 and 2. Conditions shown in Table 1 were set. Each of the test tires were arranged uniformly so that (R2−R1)/2=17.4 mm, L=19.3 mm. In Table 1, the thickness of the reinforcing rubber layer and value of rubber hardness are expressed with respect to the comparative Example 1 defined as index 100. Bead structures “a” to “d” correspond to the illustrations (a) to (d) in FIG. 3.

TABLE 1

| | | | | | | | | Reinforcing | | | | Feasibility | | |
|---|---|---|---|---|---|---|---|---|---|---|---|---|---|---|
| | | | Second moment | | | | | rubber | | | | of tire | | |
| | | | of area | | | | Protrusion | layer | | | Bead | and rim | | |
| | Height | Width | Iw | Iz | | Steel | amount | Thick- | Hard- | Tire | unseating | assembly | Ride | Bead |
| | (mm) | (mm) | (mm⁴) | (mm⁴) | Iw/Iz | Chafer | δ (mm) | ness | ness | mass | resistance | work | comfort | Structure |
| Comparative | 3.6 | 4.8 | 33 | 19 | 1.8 | With | 1.7 | 100 | 100 | 100.0 | 100 | 100 | 100 | a |
| Example 1 | | | | | | | | | | | | | | |
| Comparative | 6.9 | 2.5 | 9 | 68 | 0.1 | With | 1.7 | 100 | 100 | 98.5 | 97 | 98 | 100 | b |
| Example 2 | | | | | | | | | | | | | | |
| Example 1 | 3.0 | 5.9 | 49 | 13 | 3.9 | With | 1.7 | 100 | 100 | 99.5 | 99 | 96 | 100 | — |
| Example 2 | 2.2 | 7.8 | 87 | 7 | 12.6 | With | 1.7 | 100 | 100 | 100.0 | 99 | 93 | 100 | c |
| Example 3 | 3.0 | 12.8 | 524 | 29 | 18.2 | With | 1.7 | 100 | 100 | 101.9 | 120 | 99 | 100 | d |
| Example 4 | 3.0 | 12.8 | 524 | 29 | 18.2 | With | 1.7 | 100 | 100 | 100.8 | 108 | 100 | 100 | d |
| | | | | | | out | | | | | | | | |
| Comparative | 3.6 | 4.8 | 33 | 19 | 1.8 | With | 1.7 | 100 | 100 | 99.7 | 94 | 96 | 100 | a |
| Example 3 | | | | | | out | | | | | | | | |
| Comparative | 3.0 | 12.8 | 524 | 29 | 18.2 | With | 0.5 | 100 | 100 | 101.0 | 93 | 78 | 100 | d |
| Example 4 | | | | | | | | | | | | | | |
| Comparative | 3.0 | 12.8 | 524 | 29 | 18.2 | With | 0.0 | 100 | 100 | 100.8 | 67 | 63 | 100 | d |
| Example 5 | | | | | | | | | | | | | | |
| Example 5 | 3.0 | 12.8 | 524 | 29 | 18.2 | With | 0.7 | 100 | 100 | 101.2 | 98 | 81 | 100 | d |
| Example 6 | 3.0 | 12.8 | 524 | 29 | 18.2 | With | 1.7 | 90 | 100 | 98.3 | 99 | 99 | 95 | d |
| Example 7 | 3.0 | 12.8 | 524 | 29 | 18.2 | With | 1.7 | 100 | 85 | 100.0 | 101 | 99 | 97 | d |

Referring to Table 1, it is found that, in Examples 1 to 7, both of the bead unseating resistance and the feasibility of tire and rim assembly work were achieved at a high level. For example, comparing Comparative Example 1 and Example 2, in Example 2, the ratio Iw/Iz in the second bead was increased, and the feasibility of tire and rim assembly work was thus increased while maintaining the bead unseating resistance. In Example 3, the ratio Iw/Iz was further increased, thereby the bead unseating resistance was increased higher than that of Example 2.

Example 4 is equivalent to Example 3 except that the steel chafer is removed. As described above, the bead unseating resistance is increased in Example 3. Therefore in Example 4, although the steel chafer was eliminated, the bead unseating resistance was ensured, thereby contributing to the weight reduction of the tire. Contrarily, in Comparative Example 3 equivalent to comparative Example 1 except that the steel chafer was removed, the bead unseating resistance was not ensured.

In Comparative Examples 4 and 5, since the protruding amount 8 was small, the bead unseating resistance was relatively degraded. In Example 5, the bead unseating resistance was ensured. Examples 6 and 7 are equivalent to Example 3 except that the thickness and the hardness of the reinforcing rubber layer are reduced. In Example 3, the bead unseating resistance was increased as described above. In Example 6 and 7, although the thickness and the hardness of the reinforcing rubber layer were reduced, the bead unseating resistance was ensured, thereby contributing to the weight reduction and the improved ride comfort of the tire.

### [Amount of Lateral Displacement and Bead Compression Pressure of Second Bead]

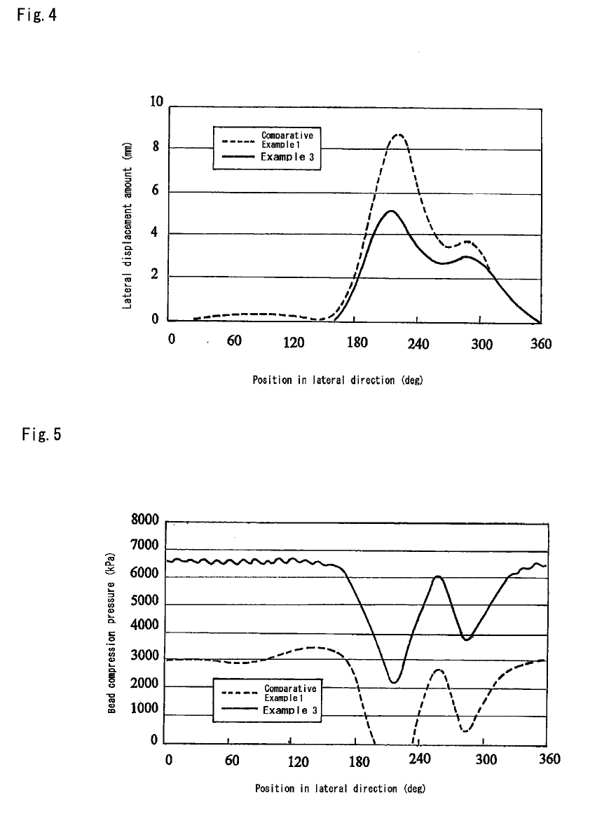

Test tires of Comparative Example 1 and Example 3 were mounted onto the respective rims (rim size: 18×8-JJ), and air pressure was set to 0 kPa. On a test machine, in a state that a lateral force equivalent to a turning state at a lateral acceleration of 10 m/sec² being applied with a vertical load of 8,000 N, amount of outward displacement of the second bead in the width direction of the tire (amount of lateral displacement) and pressure acts on the inner peripheral side face of the annular protrusion section (bead compression pressure) were measured. FIGS. 4 and 5 are graphs demonstrating the above calculation results. In the graphs, peripheral direction point on the lateral coordinates indicates the followings; i.e., 0° (360°) represents the position of non-contact top of the tire; 180° represents the position of contact center of the tire; 0 to 180° represents front side of the tire in traveling direction; and 180 to 360° represents rear side of the tire in traveling direction.

Referring to FIGS. 4 and 5, in Comparative Example 1, it is found that the second bead was largely displaced outwardly in the width direction of the tire at the rear side of the tire in traveling direction. Correspondingly, the bead compression pressure was largely lowered. Contrarily, in Example 3, the second moment of area in width direction of the second bead was increased, and thereby the amount of lateral displacement of the second bead was reduced. As a result, the bead compression pressure was ensured over the entire periphery of the second bead resulting in a superior in bead unseating resistance.

What is claimed is:

1. A run flat tire, comprising:
a pair of bead sections each including an annular first bead;
sidewall sections each extending outwardly from each of the bead sections in a diametrical direction of the tire;
reinforcing rubber layers each disposed in each of the sidewall sections; and
an annular protrusion section protruding outwardly from at least one of the bead sections in a width direction of the tire and including an annular second bead,
wherein, when the second moment of area in the width direction is defined as Iw, and the second moment of area in the diametrical direction as Iz in a cross section along the tire meridian, the relationship: 49 mm⁴≦Iw≦524 mm⁴, 7 mm⁴≦Iz≦29 mm⁴, and 3.9≦Iw/Iz≦18.2 is satisfied,
a protruding portion protruding by more than 0.5 mm from an inner peripheral face of the annular protrusion section is formed at the inner side of the second bead in the diametrical direction of the tire.
